(19) United States
(12) Patent Application Publication
(10) Pub. No.: US 2011/0041657 A1
(43) Pub. Date: Feb. 24, 2011

(54) FOLDABLE TOOL KIT HAVING A RATCHET POSITIONABLE IN MULTIPLE ORIENTATIONS

(76) Inventor: Cheng-Ching Hung, Fenyuan Township (TW)

Correspondence Address: Yen Jung Sung, 30-47 37 St., Astoria, NY, 11103, US

(21) Appl. No.: 12/542,697

(22) Filed: Aug. 18, 2009

(51) Int. Cl. B25B 15/04; B25F 1/02; B25G 1/08; B25G 1/04

(52) U.S. Cl. 81/60; 81/439; 81/177.4; 81/177.6

(57) ABSTRACT

A foldable tool kit has a ratchet head, a wrench body, a bit holder, a plurality of bits and a gripping handle. A protruding column extends from the ratchet head and is jacketed by an extension rod. The wrench body has a U-shaped cross-section, and side walls of one end of the wrench body form securing plates between which the ratchet head is pivoted. The extension rod opens out from, or closes into, a first opening of the wrench body, and tap holes are provided on side walls of another end of the wrench body. One end of the bit holder has a pivot base, and the pivot base has a pair of first pivot portions corresponding to a pivot hole from two sides of the pivot base. The grip handle also has an inverted U-shaped cross-section and two sides of one end each respectively have a through hole.

### BACKGROUND OF THE INVENTION

1. Field of the Invention

The present invention relates to a foldable tool kit having a ratchet positionable in multiple orientations, and, more particularly, to a folded ratchet wrench tool kit that is ideal for carrying in pockets or small handbags.

2. Description of the Related Art

Traditional ratchet wrenches are capable of rotation in a single direction and so make tightening or loosening of screws much easier. However most ratchet wrenches are relative heavy and so are not convenient for carrying around, and are even less convenient if a tool bit is attached to the wrench. Consequently, the typical ratchet wrench is not at all portable. Moreover, most ratchet wrenches require extra tool bit kits for storing a plurality of bits, and the extra tool bit kit only increases the inconvenience related to the ratchet wrenches.

Therefore, it is desirable to provide a foldable ratchet wrench which also provides a tool bit storage space to mitigate and/or obviate the aforementioned problems.

### SUMMARY OF THE INVENTION

A foldable tool kit having a ratchet positionable in multiple orientations comprises a ratchet head, a wrench body, a bit holder, a plurality of bits and a gripping handle. The ratchet head has an internal ratchet which is configured to provide rotation in a single direction in accordance with a switch; the switch is configured to change the rotational direction of the ratchet. A protruding column extends from the ratchet head and is jacketed by an extension rod. The wrench body has an inverted U-shaped cross-section, and two side walls of one end of the wrench body extend to form two securing plates such that the ratchet head is pivoted between the two securing plates. The extension rod is able to open out from, or close into, a first opening of the wrench body, and two side walls of another end of the wrench body respectively have a matching tap hole. The wrench body has a first positioning protrusion located adjacent to the securing plate and the first opening. The plurality of slots are located on one side of the bit holder for individual placement of the bits. One end of the bit holder has an enlarged pivot base extending along the same direction in which the bits are inserted, and the pivot base has a pair of first pivot portions corresponding to a pivot hole from two sides of the pivot base. A seal plate is disposed on the pivot base and between the pair of first pivot portions of the bit holder. The grip handle also has an inverted U-shaped cross-section and two sides of one end each respectively has a through hole, and the two side walls of the wrench body are placed in the gaps between the pair of first pivot portions of the bit holder and the seal plate. The wrench body and the bit holder together are capable of being stored in a second opening of the grip handle, and screws are placed through the matching through hole and the pivot hole and tightened into the tap hole of the wrench body such that the wrench body and the bit holder together are pivoted onto the grip handle. Furthermore, the grip handle has a second positioning protrusion on the two sides of the end opposite the pivot end, and both ends of the grip handle have a stop edge at its opening. Therefore, a folded ratchet wrench tool kit is provided by the present invention.

With the above mentioned structure, the following benefits are obtained: the size of the folded ratchet wrench tool kit is perfect for pockets or small carrying bags, and the bit holder in the ratchet wrench tool kit is capable of storing several different tool bits and folding for storage. Therefore the ratchet wrench tool kit is extremely convenient for portable usage.

Other objects, advantages, and novel features of the invention will become more apparent from the following detailed description when taken in conjunction with the accompanying drawings.

### BRIEF DESCRIPTION OF THE DRAWINGS

FIG. 1 is a perspective assembly view of the present invention.

FIG. 2 is a perspective exploded view of the present invention.

FIG. 3 is a schematic drawing of an extension rod being opened out according to the present invention.

FIG. 4 illustrates an operational state according to the present invention.

FIG. 5 is a cross-sectional drawing illustrating an operational state according to the present invention.

FIG. 6 shows the bit holder being pulled out from the second opening.

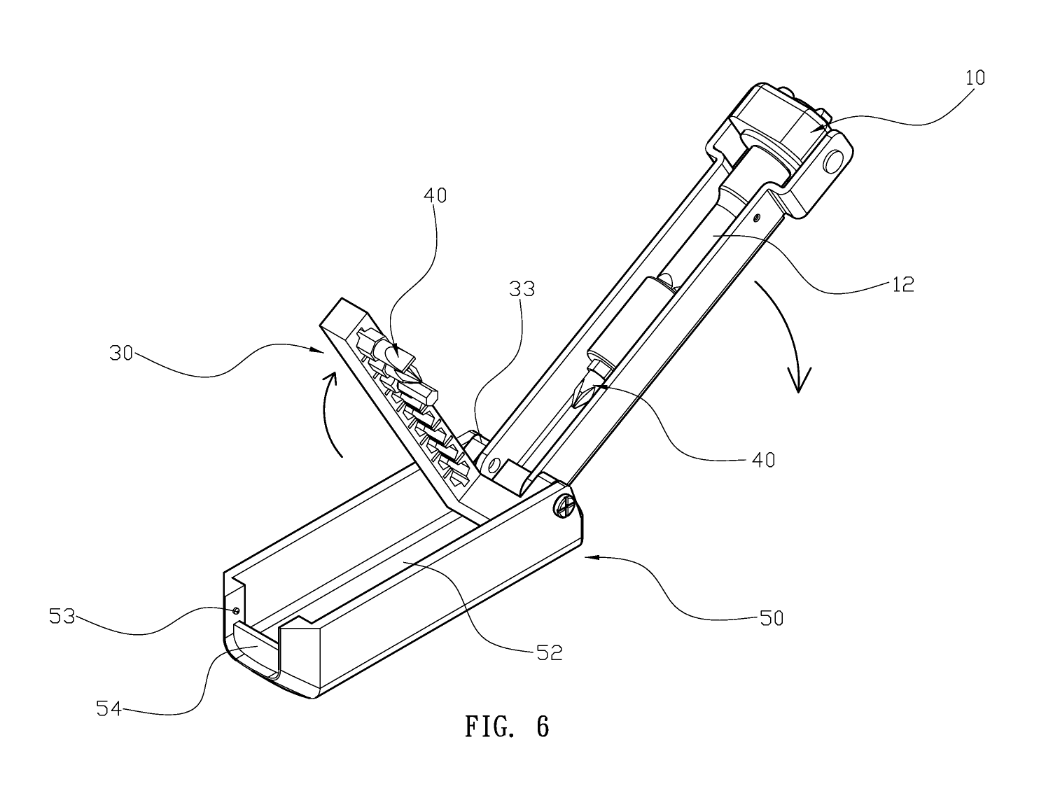

FIG. 7 is a cross-sectional drawing of the embodiment shown in FIG. 6.

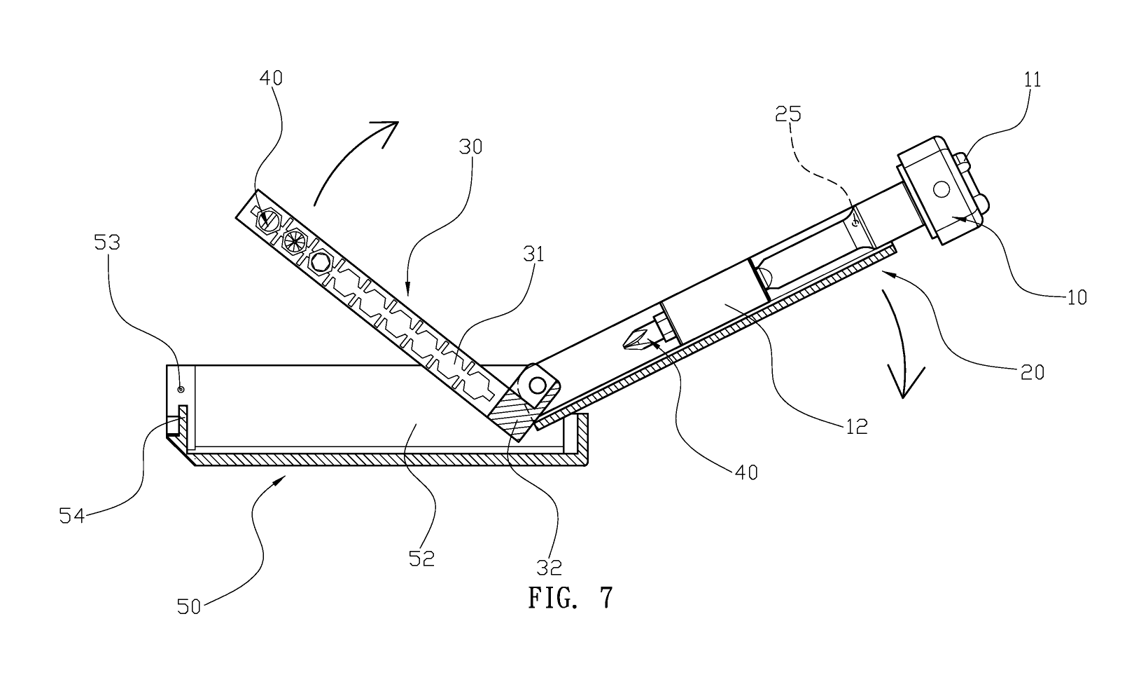

### DETAILED DESCRIPTION OF THE PREFERRED EMBODIMENT

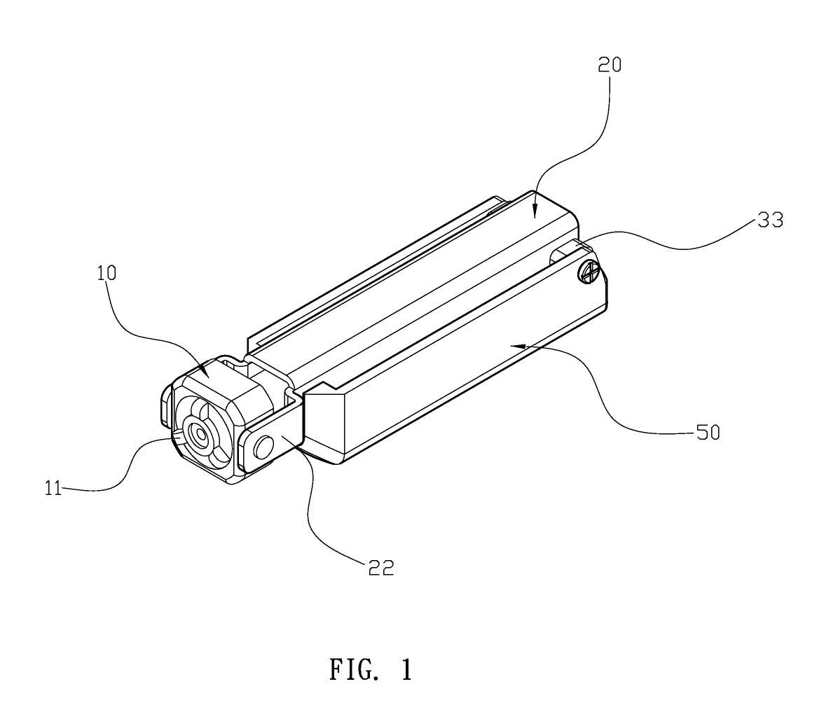

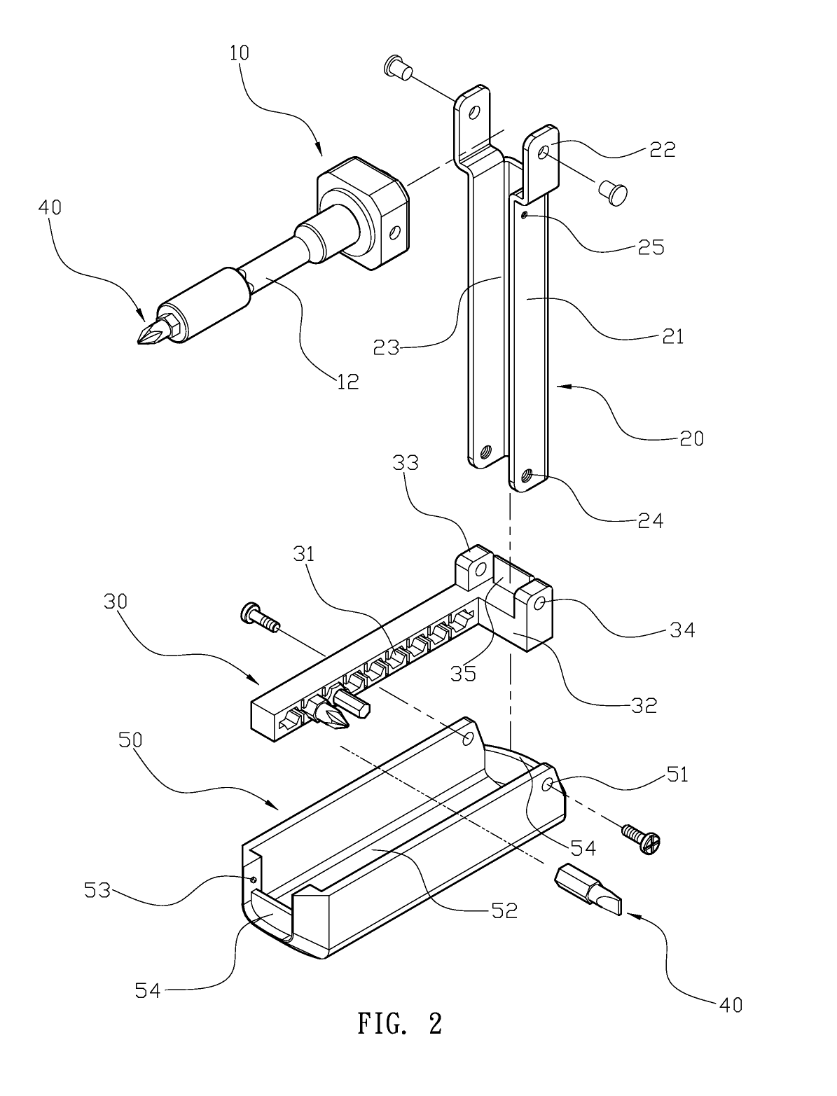

Please refer to FIG. 1 and FIG. 2. A foldable tool kit having a ratchet positionable in multiple orientations comprises a ratchet head 10, a wrench body 20, a bit holder 30, a plurality of bits 40 and a gripping handle 50. The ratchet head 10 has an internal ratchet which is configured to provide rotation in a single direction in accordance with a switch 11; the switch 11 is configured to change the rotational direction of the ratchet. A protruding column extends from the ratchet head 10 and is jacketed by an extension rod 12. The wrench body 20 has an inverted U-shaped cross-section, and two side walls 21 of one end of the wrench body 20 extend to form two securing plates 22 such that the ratchet head 10 is pivoted between the two securing plates 22. The extension rod 12 is able to open out from, or close into, a first opening 23 of the wrench body 20, and two side walls 21 of another end of the wrench body 20 respectively have a matching tap hole 24. The wrench body has a first positioning protrusion 25 located adjacent to the securing plate 22 and the first opening 23. The plurality of slots 31 are located on one side of the bit holder 30 for individual placement of the bits 40. One end of the bit holder 30 has an enlarged pivot base 32 extending along the same direction in which the bits 40 are inserted, and the pivot base 32 has a pair of first pivot portions 33 corresponding to a pivot hole 34 from two sides of the pivot base 32. A seal plate 35 is disposed on the pivot base 32 and between the pair of first pivot portions 33 of the bit holder 30. The grip handle 50 also has an inverted U-shaped cross-section and two sides of one end each respectively has a through hole 51, and the two side walls 21 of the wrench body 20 are placed in the gaps between the pair of first pivot portions 33 of the bit holder 30 and the seal plate 35. The wrench body 20 and the bit holder 30 together are capable of being stored in a second opening 52 of the grip handle 50, and screws are placed through the matching through hole 51 and the pivot hole 34 and tightened into the tap hole 24 of the wrench body 20 such that the wrench body 20 and the bit holder 30 together are pivoted onto the grip handle 50. Furthermore, the grip handle 50 has a second positioning protrusion 53 on the two sides of the end opposite the pivot end, and both ends of the grip handle 50 have a stop edge 54 at its opening.

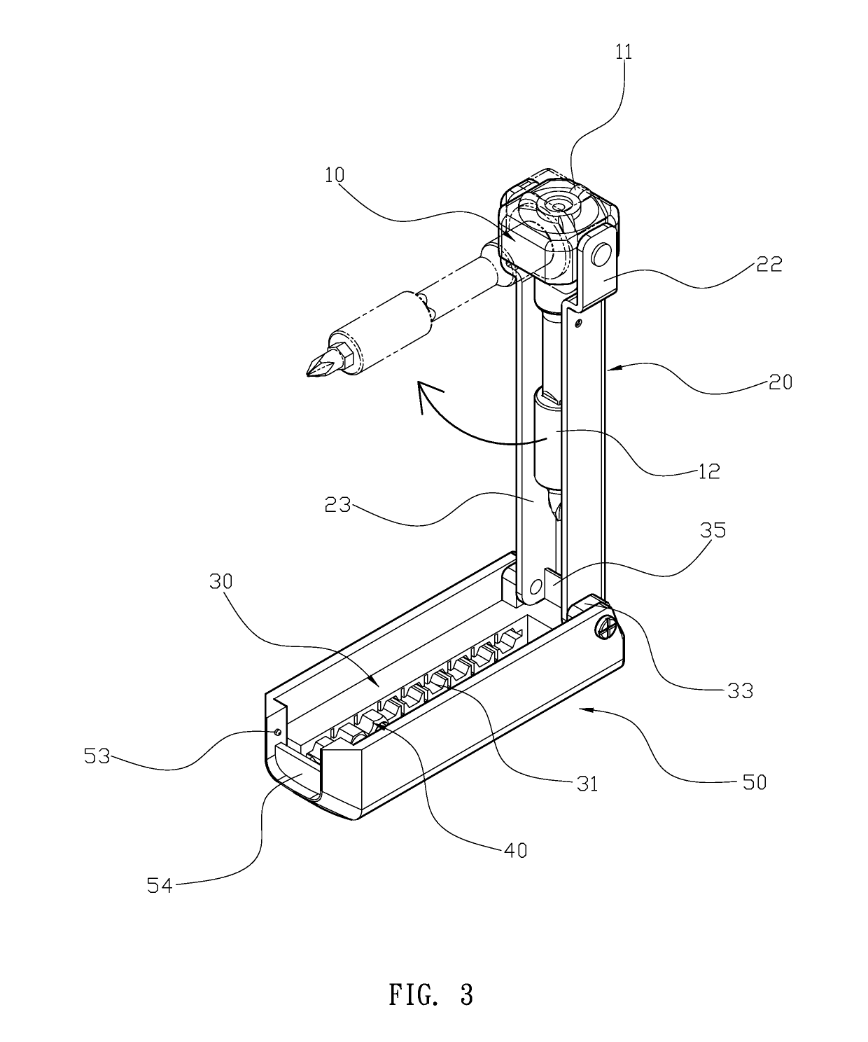

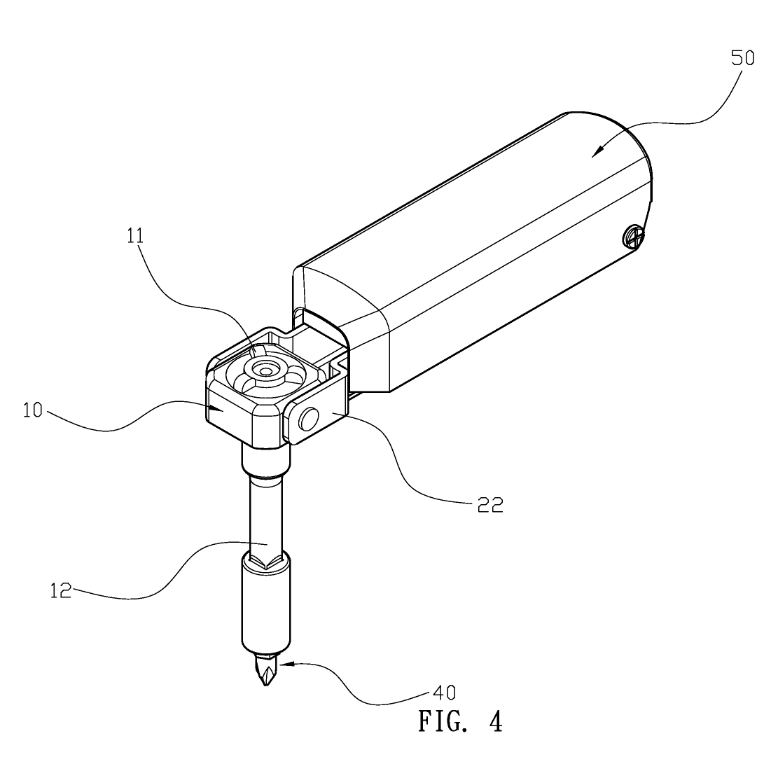

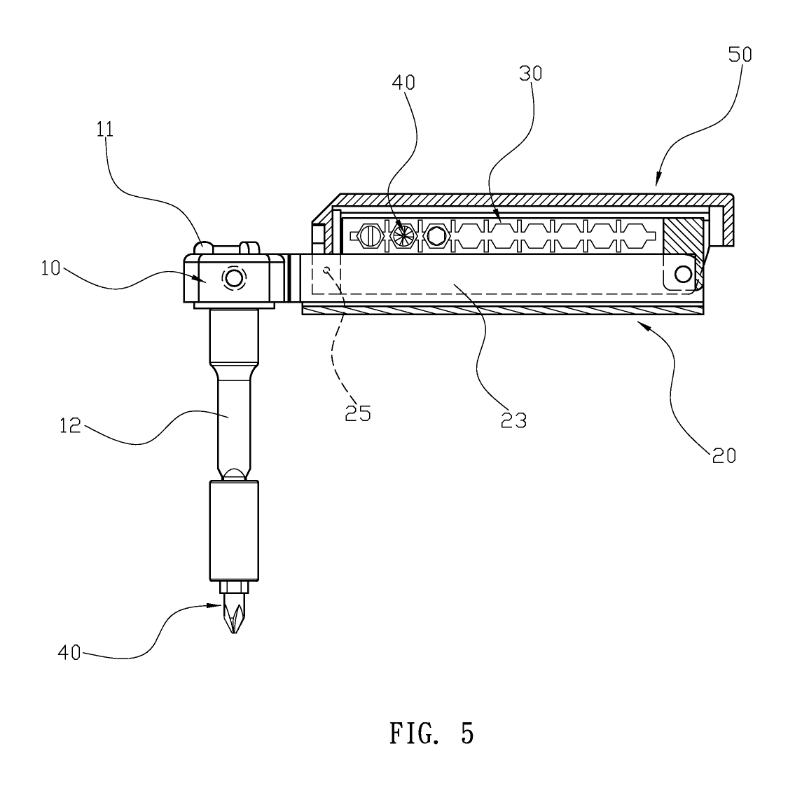

Please refer to FIG. 3 to FIG. 5. During actual operation, a user pulls the grip handle 50 open and uses the ratchet head 10 to bring the extension rod 12 away from the first opening 23 of the wrench body 20, and then the user closes back the grip handle 50 so that the second positioning protrusions 53 press against the two side walls 21 of the wrench body 20 to prevent the grip handle 50 from being opened randomly. After the extension rod 12 is pulled out, using the one-way rotational movement of the ratchet head 10, the bit 40 mounted on the extension rod 12 can be used for quickly tightening or loosing screws.

Moreover, if the user wants to change to a different bit 40, he or she needs only to open the grip handle 50 again and pull the wrench body 20 away from the second opening 52 so that the wrench body 20 presses against the bit holder 30 with its pivot end to lift up the bit holder 30, and the bit holder 30 is moved out from the second opening 52 of the grip handle 50 to facilitate changing of the bit. As for storage, the user separately pushes the extension rod 12 and the wrench body 20 back into the first opening 23 and the second opening 52 to fold the wrench tool kit all together. Meanwhile, the first positioning protrusion 25 presses against the extension rod 12 to prevent rattling of the extension rod 12.

With the above mentioned structure, the following benefits are obtained: the size of the folded ratchet wrench tool kit is perfect for pockets or small carrying bags, and the bit holder 30 in the ratchet wrench tool kit is capable of storing several different tool bits 40 and folding for storage. Therefore the ratchet wrench tool kit is extremely convenient for portable usage.

Although the present invention has been explained in relation to its preferred embodiment, it is to be understood that many other possible modifications and variations can be made without departing from the spirit and scope of the invention as hereinafter claimed.

What is claimed is:

1. A foldable tool kit having a ratchet positionable in multiple orientations comprising: a ratchet head, a wrench body, a bit holder, a plurality of bits and a gripping handle, wherein:
the ratchet head has an internal ratchet configured to provide rotation in a single direction in accordance with a switch, the switch configured to change the rotational direction of the ratchet, a protruding column extending from the ratchet head and jacketed by an extension rod;
the wrench body has an inverted U-shaped cross-section and two side walls of one end of the wrench body extending to form two securing plates such that the ratchet head is pivoted between the two securing plates; wherein the extension rod is able to open out from or close into a first opening of the wrench body, and two side walls of another end of the wrench body respectively have a matching tap hole;
a plurality of slots are located at a side of the bit holder for individual placement of the bits, one end of the bit holder has an enlarged pivot base extending along the same direction in which the bits are inserted, the pivot base has a pair of first pivot portions individually with a pivot hole extending from two sides of the pivot base; and
the grip handle has an inverted U-shaped cross-section and two sides of one end respectively having a through hole, the two side walls of the wrench body placed between the pair of first pivot portions of the bit holder, the wrench body and the bit holder together capable of being stored in a second opening of the grip handle, and screws placed through the matching through hole and the pivot hole and tightened into the tap hole of the wrench body such that the wrench body and the bit holder together are pivoted onto the grip handle.

2. The foldable tool kit as claimed in claim 1, wherein the wrench body has a first positioning protrusion located adjacent to the securing plate and the first opening.

3. The foldable tool kit as claimed in claim 1, wherein a seal plate is disposed on the pivot base and between the pair of first pivot portions of the bit holder.

4. The foldable tool kit as claimed in claim 1, wherein the grip handle has a second positioning protrusion on the two sides of the end opposite the pivot end.

5. The foldable tool kit structure as claimed in claim 1, wherein both ends of the grip handle have a stop edge at its opening.
